(19) United States
(12) Patent Application Publication
(10) Pub. No.: US 2026/0310149 A1
(43) Pub. Date: Oct. 8, 2026

(54) COMPUTER-IMPLEMENTED METHOD FOR TRAINING AT LEAST ONE MODEL FOR CONTROLLING ASSET ALLOCATION IN A DISTRIBUTED ENERGY SYSTEM

(71) Applicant: ELISA OYJ, Helsinki (FI)

(72) Inventors: Jukka-Pekka SALMENKAITA, Helsinki (FI); Esko HEINONEN, Helsinki (FI); Simon HOLMBACKA, Helsinki (FI)

(73) Assignee: ELISA OYJ, Helsinki (FI)

(21) Appl. No.: 19/472,538

(22) PCT Filed: Apr. 8, 2024
(86) PCT No.: PCT/FI2024/050158

§ 371 Date: Oct. 3, 2025

(30) Foreign Application Priority Data
Apr. 17, 2023 (FI) 20235432

(51) Int. Cl. G05B 13/02; H02J 3/38; H02J 103/30

(52) U.S. Cl. CPC G05B 13/027; H02J 3/381; H02J 2103/30

(57) ABSTRACT

According to an embodiment, a computer-implemented method for training at least one model for controlling as-set allocation in a distributed energy system comprises obtaining historical data about the distributed energy system; training a data simulator to generate future data for future distributed energy system conditions using the historical data; generating a plurality of new data for new distributed energy system conditions using the trained data simulator; and training at least one model for controlling asset allocation in the distributed energy system in the new distributed energy system conditions using the plurality of new data.

### TECHNICAL FIELD

The present disclosure relates to distributed energy systems, and more particularly to a computer-implemented method for training at least one model for controlling asset allocation in a distributed energy system, a computing device, and a computer program product.

### BACKGROUND

A distributed energy storage (DES) can comprise a large number of nodes, and each node can be powered by, for example, the power grid or by a battery system connected to the node. Many asset allocation decisions, such as how much capacity to offer for an automatic frequency restoration reserve (aFRR) market, need to be done in advance, typically approximately one day earlier than the operations. Further, asset allocation optimization is not deterministic, since not all needed information is known in advance and activation of allocated capacity is stochastic.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

It is an objective to provide a computer-implemented method for training at least one model for controlling asset allocation in a distributed energy system, a computing device, and a computer program product. The foregoing and other objectives are achieved by the features of the independent claims. Further implementation forms are apparent from the dependent claims, the description and the figures.

According to a first aspect, a computer-implemented method for training at least one model for controlling asset allocation in a distributed energy system comprises: obtaining historical data about the distributed energy system; training a data simulator to generate future data for future distributed energy system conditions using the historical data; generating a plurality of new data for new distributed energy system conditions using the trained data simulator; and training at least one model for controlling asset allocation in the distributed energy system in the new distributed energy system conditions using the plurality of new data. The method can, for example, efficiently train the at least one model for controlling asset allocation in the distributed energy system.

In an implementation form the first aspect, the training the at least one model for controlling asset allocation in the distributed energy system in the new distributed energy system conditions using the plurality of new data comprises: obtaining at least one seed model from a database based at least on the new distributed energy system conditions; and using the at least one seed model as a starting point for training the at least one model for controlling asset allocation in the distributed energy system in the new distributed energy system conditions. The method can, for example, efficiently train the at least one model for controlling asset allocation in the distributed energy system using the at least one seed model.

In another implementation form of the first aspect, each seed model of the at least one seed model comprises at least one asset allocation plan for the distributed energy system, energy and/or power characteristics of at least one asset of the at least one asset allocation plan, statistical information about distributed energy system conditions at a time of execution of the at least one asset allocation plan, and/or an outcome probability distribution of the at least one asset allocation plan. The method can, for example, efficiently select an appropriate at least one seed model for the new distributed energy system conditions.

In another implementation form of the first aspect, the statistical information about the distributed energy system conditions at the time of execution of the at least one asset allocation plan comprises at least one of: distributed energy system conditions before the time of execution of the allocation plan, prices before and/or during the time of execution of the at least one asset allocation plan, and/or frequency restoration reserves activation request signals before and/or during the time of execution of the at least one asset allocation plan. The method can, for example, efficiently select an appropriate at least one seed model based on the statistical information about the distributed energy system conditions.

In another implementation form of the first aspect, the outcome probability distribution of the at least one asset allocation plan is based on a plurality of simulations and/or an observed outcome probability distribution of the at least one asset allocation plan. The method can, for example, more accurately select an appropriate at least one seed model since the outcome probability distribution of the at least one asset allocation plan can more accurately reflect the suitability of the at least one asset allocation plan.

In another implementation form of the first aspect, the method further comprises scaling the at least one seed model according to a capacity characteristic of the at least one seed model and a capacity characteristic of the new distributed energy system conditions. The method can, for example, make the at least one seed model more suitable for the new distributed energy system conditions.

In another implementation form of the first aspect, the training the at least one model for controlling asset allocation in the distributed energy system in the new distributed energy system conditions using the plurality of new data further comprises: training a plurality of models for the new distributed energy system conditions by using the at least one seed model as a starting point and by simulating each model in plurality of models a plurality of times, thus obtaining a plurality of trained models; recording an outcome probability distribution of each trained model in the plurality of trained models; and selecting a trained model, from the plurality of trained models, for execution based at least on the outcome probability distribution of each trained model in the plurality of trained models and at least one selection criteria. The method can, for example, efficiently choose the trained model for execution.

In another implementation form of the first aspect, the method further comprises storing at least the selected trained model in the database. The method can, for example, improve training of future models by storing at least the selected trained model in the database as a seed model.

In another implementation form of the first aspect, the method further comprises storing at least one non-selected trained model, from the plurality of trained models, in the database based at least on the outcome probability distribution of each trained model in the plurality of trained models and the at least one selection criteria. The method can, for example, improve training of future models by storing at least one non-selected trained model in the database as a seed model.

In another implementation form of the first aspect, the training the at least one model for controlling asset allocation in the distributed energy system in the new distributed energy system conditions using the plurality of new data comprises training the at least one model for controlling asset allocation in the distributed energy system in a plurality of distributed energy system conditions. The method can, for example, efficiently train a model that can function in a plurality of distributed energy system conditions.

In another implementation form of the first aspect, the training the at least one model for controlling asset allocation in the distributed energy system in the new distributed energy system conditions allows a human to adjust the training. The method can, for example, efficiently adjust the training via the human adjustment.

In another implementation form of the first aspect, the training the at least one model for controlling asset allocation in the distributed energy system in the new distributed energy system conditions comprises reinforcement learning. The method can, for example, efficiently train the at least one model using reinforcement learning.

According to a second aspect, a computing device comprises at least one processor and at least one memory including computer program code, the at least one memory and the computer program code being configured to, with the at least one processor, cause the computing device to perform the method according to the first aspect.

According to a third aspect, a computer program product comprises program code configured to perform the method according to the first aspect when the computer program product is executed on a computer.

Many of the attendant features will be more readily appreciated as they become better understood by reference to the following detailed description considered in connection with the accompanying drawings.

### DESCRIPTION OF THE DRAWINGS

In the following, example embodiments are described in more detail with reference to the attached figures and drawings, in which:

FIG. 1 illustrates a flow chart representation of a method according to an embodiment;

FIG. 2 illustrates a schematic representation of model training according to an embodiment;

FIG. 3 illustrates a plot representation an outcome probability distribution according to an embodiment;

FIG. 4 illustrates a plot representation an outcome probability distribution according to another embodiment; and

FIG. 5 illustrates a schematic representation of a computing device according to an embodiment.

In the following, like reference numerals are used to designate like parts in the accompanying drawings.

### DETAILED DESCRIPTION

In the following description, reference is made to the accompanying drawings, which form part of the disclosure, and in which are shown, by way of illustration, specific aspects in which the present disclosure may be placed. It is understood that other aspects may be utilised, and structural or logical changes may be made without departing from the scope of the present disclosure. The following detailed description, therefore, is not to be taken in a limiting sense, as the scope of the present disclosure is defined by the appended claims.

For instance, it is understood that a disclosure in connection with a described method may also hold true for a corresponding device or system configured to perform the method and vice versa. For example, if a specific method step is described, a corresponding device may include a unit to perform the described method step, even if such unit is not explicitly described or illustrated in the figures. On the other hand, for example, if a specific apparatus is described based on functional units, a corresponding method may include a step performing the described functionality, even if such step is not explicitly described or illustrated in the figures. Further, it is understood that the features of the various example aspects described herein may be combined with each other, unless specifically noted otherwise.

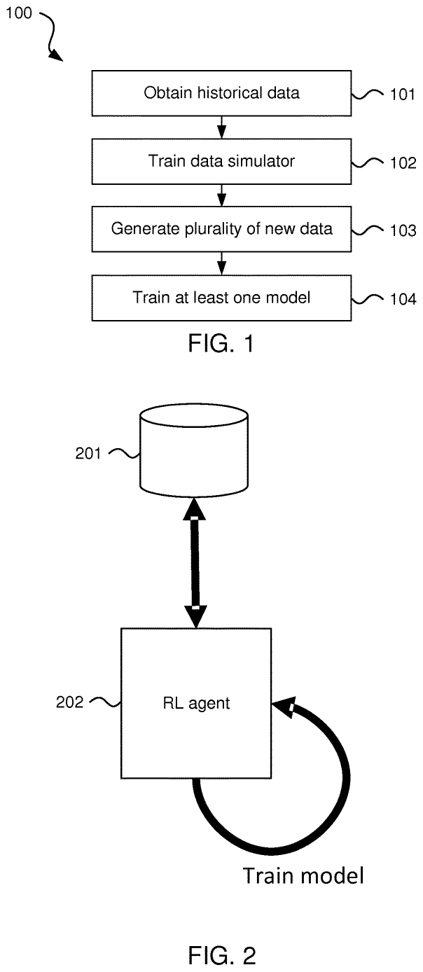

FIG. 1 illustrates a flow chart representation of a method according to an embodiment.

According to an embodiment, a computer-implemented method 100 for training at least one model for controlling asset allocation in a distributed energy system comprises obtaining 101 historical data about the distributed energy system.

Herein, an asset may refer to any part/component of the distributed energy system that can be used for, for example, power grid frequency balancing. For example, the distributed energy system may comprise a plurality of nodes, each node comprising a battery that can be used to provide power to the power grid during up regulation and/or to take power from the power grid during down regulation. Allocating an asset may comprise, for example, providing an asset for power grid frequency balancing.

The historical data about the distributed energy system may comprise, for example, historical distributed energy system conditions at various points of time, such as days, historical information about prices, such as electricity prices, such as day-ahead and/or intraday market prices, the capacity prices on the reserve markets, such as for automatic frequency restoration reserve (aFRR) up regulation and aFRR down regulation, and/or energy price in the aFRR market, and/or historical frequency restoration reserves activation request signals.

The method 100 may further comprise training 102 a data simulator to generate future data for future distributed energy system conditions using the historical data.

The data simulator may also be referred to as data generator similar.

Herein, distributed energy system conditions may comprise any information that can affect the distributed energy system. Examples of such information are disclosed herein.

Distributed energy system conditions may also be referred to as market conditions, environmental conditions, or similar.

The future distributed energy system conditions may correspond to, for example, distributed energy system conditions during any period of time, such as a day, in the future. For example, the data simulator may be configured to output the future data based on input parameters describing the future point of time, such as a day. For example, after the data simulator has been trained, the data simulator may take as an input descriptive parameters about the future time instance, such as “a Monday in October”, and generate data about the distributed energy system for that future time instance.

The history of activated aFRR signals with fine time resolution may not easily available. However, the activated energies for both up and down regulation and procured capacities on hourly level can be. As the activations may be done pro rata, the activated energy can be determined with a certain bid size.

The historical data can be used to simulate the performance with different models. For example, it can be observed what kind of activations there can be with the chosen model hour by hour. For example, at the beginning of a day there may be some known state of charge in the batteries of the assets. Then, hour by hour, it can be observed, how the activations would affect the state of charge of the batteries. At the same time, the revenues and possible sanctions caused by lack/excess of energy can be computed. Thus, the models can be evaluated in terms of, for example, revenue and performance in general.

The historical data can be used to, for example, simulate full daily profiles by using historical days and observing hour by hour the likelihood of various events with certain models. However, there may only be a certain amount of historical data available.

Alternatively or additionally, the historical data can be used by, for example, taking the historical data and grouping the historical data into hourly datasets, such as data for each of the 24 hours of a day. Then, simulation can be performed hour by hour by sampling from the historical data for each hour of the day. This approach can be refined by fitting distributions to the hourly data and that way increasing the amount of data available. However, this can break the correlation between consecutive hours.

The data simulator can generate future data for future distributed energy system conditions using the historical data by, for example, utilising the hourly sampling above. Alternatively or additionally, the data simulator can, for example, create Markov chains base on the historical data and generate the future data using the Markov chains. This can, for example, preserve some of the correlation between hours.

Alternatively or additionally, the data simulator can generate future data for future distributed energy system conditions using other approaches, such as generative adversarial networks (GAN), variational autoencoder (VAE) approaches, and/or deep learning. These models can be trained on the historical data and then used to generate future data for future distributed energy system conditions.

The method 100 may further comprise generating 103 a plurality of new data for new distributed energy system conditions using the trained data simulator.

The new distributed energy system conditions may correspond to, for example, energy system conditions during a specific day. For example, the method 100 may be used each day to train at least one model for controlling asset allocation in the distributed energy system for that day.

The method 100 may further comprise training 104 at least one model for controlling asset allocation in the distributed energy system in the new distributed energy system conditions using the plurality of new data.

In order to simulate new data for the distributed energy system conditions, the trained data simulator can be provided with summary statistical information about the new distributed energy system conditions. The data used in training at least one model should come from same distribution as indicated.

The method 100 can utilise learnings from the generated plurality of new data for the training of the at least one model.

Distributed energy storage (DES) and/or other virtual power plant solution can control thousands of battery units at different sites/nodes. Many asset allocation decisions, such as how much capacity to offer for aFRR market, need to be done in advance, typically approximately one day before the operations.

For example, an asset allocation can state the following and similar bids for all hours of the day:
12.00: aFRR up regulation bid 1 megawatts (MW), load shift up bid 1 MW
13.00: aFRR down regulation bid 2 MW, load shift up bid 2 MW
14.00: aFRR down regulation bid 3 MW, load shift down bid 1 MW

Asset allocation optimization is not deterministic, since, for example, all price points are not known in advance. Further, activation of allocated capacity can be stochastic, since the amount of activated assets can be controlled by the transmission system operator, not the asset owner/operator.

For example, aFRR activations can be based on the grid conditions at that point in time, which cannot be precisely forecasted.

One approach to handle this stochasticity could be to simulate a large number of outcomes for each asset allocation plan and then select a plan that has desirable characteristics. However, if this is done from scratch for every round of asset allocation, it can become computationally ineffective.

The method 100 can, for example, be able to cope with the stochasticity of asset allocation in a distributed energy system in effective manner.

The method 100 can may be able to efficiently adapt to new circumstances, such as new expected price points, different patterns of asset activation.

Training a model by simply using historical data as-is may not be optimal, as the controller may overlearn specific historical patterns that are not generalizable for future events.

The method 100 can use historical data to provide examples of distributions of data in a given market/environment conditions. This historical distribution can be used to sample data for the data simulator. The sampling may comprise, for example, Monte Carlo sampling of one or multiple variables. The data simulator may comprise, for example, a synthetic data generator which recreates the stochastic elements.

Using the method 100, the historical data can be used to provide a large simulation capacity of future scenarios with generalization capability.

For example, the method 100 may, instead of using the historical data as-is, use the historical data to recreate, for example, one market day many times using the trained data simulator. The at least one model can be trained based on the simulated output rather than from data from a single historical data point.

An activation signal may be provided by, for example, a grid operator. When working in national frequency reserve markets, the grid operator can require each participant to deliver a selected amount of frequency balancing capacity for the market during the time of resource activation. The activated frequency balancing capacity is usually not allowed to fluctuate significantly from its intended setpoint, and the participants can be sanctioned in case the participant is not able to deliver steady frequency balancing capacity for the market.

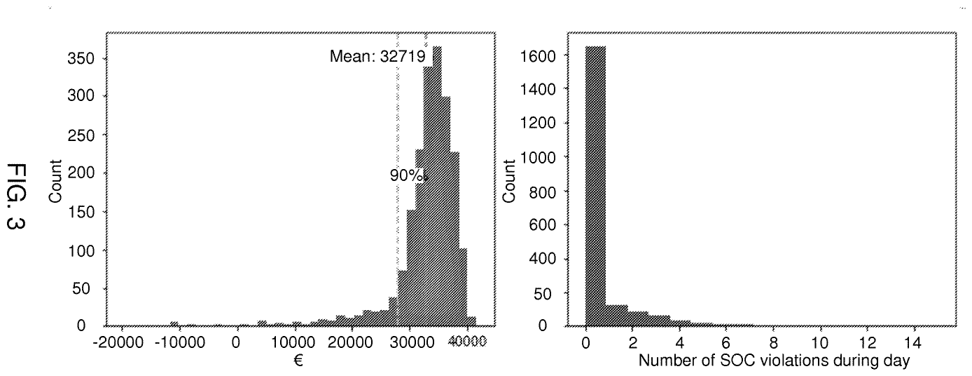

FIG. 2 illustrates a schematic representation of model training according to an embodiment.

According to an embodiment, the training 104 the at least one model for controlling asset allocation in the distributed energy system in the new distributed energy system conditions using the plurality of new data comprises: obtaining at least one seed model from a database 201 based at least on the new distributed energy system conditions; and using the at least one seed model as a starting point for training the at least one model for controlling asset allocation in the distributed energy system in the new distributed energy system conditions.

The database 201 may comprise, for example, known good models as seed models. The at least one seed model can be used as a baseline for training the at least one model. Training the at least one model can comprise using at least one known good model as a seed for iteration. The iteration can be performed by, for example, a reinforcement learning (RL) agent 202. The RL agent 202 can evolve further when new models are created.

For example, a record of “winning” asset allocation strategies and their environmental conditions can be stored in the database 201, and training for new environmental conditions, such as a new market day, can start by being seeded by known good solutions to similar conditions.

The obtaining at least one seed model from the database 201 based at least on the new distributed energy system conditions may comprise, for example, finding at least one seed model in the database 201 that matches the new distributed energy system conditions as closely as possible.

According to an embodiment, the training 104 the at least one model for controlling asset allocation in the distributed energy system in the new distributed energy system conditions comprises reinforcement learning.

In reinforcement learning, an RL agent/controller 202 can learn to achieve objectives in simulated, including stochastic, environments.

The obtaining at least one seed model from a database based at least on the new distributed energy system conditions may comprise, for example, analysing the new distributed energy system conditions and searching the database 201 for models applicable for earlier conditions similar to the new distributed energy system conditions. For example, the searching may comprise searching for Mondays in October. The analysing the new distributed energy system conditions may comprise, for example, forming statistical information about the new distributed energy system conditions.

According to an embodiment, each seed model of the at least one seed model comprises at least one asset allocation plan for the distributed energy system, energy and/or power characteristics of at least one asset of the at least one asset allocation plan, statistical information about distributed energy system conditions at a time of execution of the at least one asset allocation plan, and/or an outcome probability distribution of the at least one asset allocation plan.

The at least one asset allocation plan for the distributed energy system may comprise, for example, a plurality of actions and at which times these actions are to be performed.

For example, an asset allocation plan can indicate that at 8.00 on a specific day, a bid of 1 MW aFRR up/down regulation bid and a 2 MW load shift up/down bid should be performed.

The energy and/or power characteristics of at least one asset of the at least one asset allocation plan may comprise, for example, aggregate characteristics of the overall capacity being allocated. For example, 30 MWh of usable energy storage, 10 MW average adjustable power, 30%:70% average up:down regulation power split.

An outcome probability distribution can describe how likely different outcomes are for a specific asset allocation plan. For example, an outcome can comprise whether the allocation plan failed to deliver promised capacity. This may occur due to, for example, empty/full batteries at an allocated node or nodes. The training 104 of the at least one model can try to find the optimal balance between operational hours and failing occurrences by, for example, maximizing operational hours while minimizing the failings. This can also maximize other variables, such as revenue.

According to an embodiment, the statistical information about the distributed energy system conditions at the time of execution of the at least one asset allocation plan comprises at least one of: distributed energy system conditions before the time of execution of the allocation plan, prices before and/or during the time of execution of the at least one asset allocation plan, and/or frequency restoration reserves activation request signals before and/or during the time of execution of the at least one asset allocation plan.

The prices before and/or during the time of execution of the at least one asset allocation plan may comprise, for example, electricity prices, such as dayahead and/or intraday market prices, the capacity prices on the reserve markets, such as for aFRR up regulation and aFRR down regulation, and/or energy price in the aFRR market.

The distributed energy system conditions before the time of execution of the allocation plan may comprise, for example, statistical information of the prevailing market conditions at the time of plan execution and/or past market conditions.

The statistical information about the distributed energy system conditions may be available in various time granularities. For example, the market may be operated hourly or with a 15-min resolution. Longer trends in the data may also be considered.

According to an embodiment, the outcome probability distribution of the at least one asset allocation plan is based on a plurality of simulations and/or an observed outcome probability distribution of the at least one asset allocation plan.

The outcome probability distribution of the at least one asset allocation plan may be based on a plurality of simulations by, for example, simulating the at least one asset allocation plan a plurality of times and observing the resulting outcome probability distributions.

The observed outcome probability distribution of the at least one asset allocation plan may comprise a probability distribution that is observed when the at least one asset allocation plan is executed.

In some embodiments, the at least one asset allocation plan may comprise a plurality of asset allocation plans. The outcome probability distribution of each asset allocation plan can be based on a plurality of simulations and/or an observed outcome probability distribution of the asset allocation plan.

The outcome of an asset allocation plan may not be single value but an outcome probability distribution. An asset allocation plan may be simulated a plurality of times with the same input parameters. The stochastic nature of the simulation can result in different results for every simulation. The method 100 can analyse the distribution of an outcome, such as revenue, and determine which distribution is the best one with heuristics. Best may not correspond to only maximal expected outcome, but also the probability of getting a rather high outcome or low risk of getting very small outcome.

The method 100 may further comprise reducing a number of models in the at least one model. For example, number of models in the at least one model can be reduced while maximizing the diversity of remaining models. For example, the method 100 may fetch models that are very different while the conditions are the same. This can enable the RL agent 202 to explore a larger state space more easily.

According to an embodiment, the method 100 further comprises scaling the at least one seed model according to a capacity characteristic of the at least one seed model and a capacity characteristic of the new distributed energy system conditions.

The capacity characteristic may refer to energy and/or power capacity of one or more assets. The capacity characteristic may comprise, for example, at least one of the following: average up regulation power (W), average down regulation power (W) and/or average energy storage capacity (Wh). For example, a seed model in the at least one seed model may comprise an asset allocation plan for assets having a specific amount of power capacity and/or energy capacity to be used for power grid frequency balancing. On the other hand, the new distributed energy system conditions may require a different amount of power capacity and/or energy capacity. Thus, it may be beneficial to scale the seed model to better match the new distributed energy system conditions.

For example, the remaining models, after reducing the number of models in the at least one model, can be scaled according to capacity characteristics to approximately match the capacity characteristics of the system for which new model will be trained.

Scaling can be advantageous if, for example, models from significantly different systems are combined together. For example, one system could be 50 MWh, 20 MW, and another could be 10 MWh, 2 MW system. With scaling, they can be made comparable. If a third system was 10 MWh 30 MW it would probably be so different that models relevant for that system are not useful seeds for the first two systems. Selecting the optimal seed model may be based on detecting which available model is closest for at least one capacity characteristic of the new system, when scaled. For example, a seed model of 50 MWh/20 MW can be an optimal seed model for a new system of 100 MWh/40 MW, whereas a seed model of 10 MWh/2 MW can be an optimal seed model for a new system of 20 MWh/4 MW.

The training for new models can be done starting from the at least one seed model, after possible scaling, as a starting point.

According to an embodiment, the training 104 the at least one model for controlling asset allocation in the distributed energy system in the new distributed energy system conditions using the plurality of new data further comprises: training a plurality of models for the new distributed energy system conditions by using the at least one seed model as a starting point and by simulating each model in plurality of models a plurality of times, thus obtaining a plurality of trained models; recording an outcome probability distribution of each trained model in the plurality of trained models; and selecting a trained model, from the plurality of trained models, for execution based at least on the outcome probability distribution of each trained model in the plurality of trained models and at least one selection criteria.

During the training, the new model candidates can be simulated many times. The outcome probability distribution of each model can be recorded. The outcome probability distribution can be compared to select one or several models that have superior characteristics in some desirability criteria, such as highest expected value, least likelihood for unacceptable low performance etc.

The outcome of the executed plan can also be recorded.

According to an embodiment, the method 100 further comprises storing at least the selected trained model in the database 201.

According to an embodiment, the method 100 further comprises storing at least one non-selected trained model, from the plurality of trained models, in the database 201 based at least on the outcome probability distribution of each trained model in the plurality of trained models and the at least one selection criteria.

One of the models can be selected for execution. The selected model, and optionally other possibly superior but different models, can be recorded in the database 201 to be used as future seeds.

In some embodiments, the storing at least one non-selected trained model may comprise storing at least one bad model, i.e. a model that does not comply with the at least one selection criteria. The information comprised in the at least one bad model can be used to not influence the seed model. For example, an extreme corner case of a bad model may comprise only discharging or only charging assets a whole day. By storing such bad models, it can be checked that a seed model does resemble such a known bad model.

According to an embodiment, the training 104 the at least one model for controlling asset allocation in the distributed energy system in the new distributed energy system conditions allows a human to adjust the training.

The human can, for example, guide the training of the model with various type of interactions. For example, the human can rate the models generated during the training and guide the learning to some direction with those ratings. Alternatively or additionally, the user may guide with “rather good plans” as starting points. This may also be referred to as reinforcement learning with human advice or reinforcement learning with human feedback. For example, reinforcement learning with human advice/feedback may comprise utilising a known good plan, made by for example a human or some other method, to guide the RL agent into certain direction in the training. Alternatively or additionally, this could be used as a starting point to speed up the training process.

Further, a human may adjust the trained models after the training by the method 100.

According to an embodiment, the training 104 the at least one model for controlling asset allocation in the distributed energy system in the new distributed energy system conditions using the plurality of new data comprises training the at least one model for controlling asset allocation in the distributed energy system in a plurality of distributed energy system conditions.

The at least one model trained for controlling asset allocation in the distributed energy system in a plurality of distributed energy system conditions can learn a strategy for all conditions in the plurality of distributed energy system conditions and be supported to do so by getting statistical information about the conditions.

If the state space is small enough, it can be practical to train a model for the plurality of distributed energy system conditions, since a small number of combinations needs to be tried and a local or the global optimum can be found. In very large state spaces, the global optimum may be challenging to find but the training may still find good enough gradients to quickly find a rather good solution.

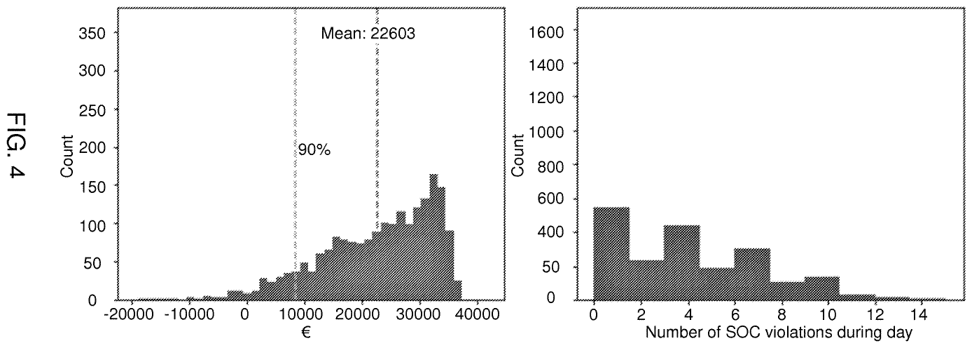

FIG. 3 illustrates a plot representation an outcome probability distribution according to an embodiment.

The embodiment of FIG. 3 illustrates two outcome probability distributions of a model. In one of the outcome probability distributions, the outcome corresponds to revenue, and in the other outcome probability distribution, the outcome corresponds to a number of state of charge (SOC) violations. A SOC violation refers to a situation where the allocation assets do not have sufficient charge to deliver the promised capacity.

In some embodiments, the outcome probability distribution may comprise a plurality of outcome probability distributions. For example, in the embodiment of FIG. 3, two outcome probability distribution in terms of two different outcomes are illustrated. The mode for execution can be chosen based on the any number of outcome probability distributions.

The model corresponding to the outcome probability distributions illustrated in the embodiment of FIG. 3 may be considered a well performing model. The average revenue is high and SOC violations are unlikely.

The distribution illustrated in the embodiment of FIG. 3 may represent a desirable outcome probability distribution. There is a good probability that the real outcome is quite close to the maximum outcome.

FIG. 4 illustrates a plot representation an outcome probability distribution according to another embodiment.

The embodiment of FIG. 4 illustrates two outcome probability distributions of a model. In one of the outcome probability distributions, the outcome corresponds to revenue, and in the other outcome probability distribution, the outcome corresponds to a number of state of charge (SOC) violations.

The model corresponding to the outcome probability distributions illustrated in the embodiment of FIG. 4 may be considered a not so good model. The average revenue is lower and SOC violations are more likely than, for example with the model of FIG. 3.

Out of the embodiments of FIG. 3 and FIG. 4, it may be better to pick the model resulting in the embodiment of FIG. 3 because it will give a good outcome with a high probability. The embodiment of FIG. 4 can give even higher outcome but only in rare occasions.

Alternatively or additionally, a good model can also be chosen using various other criteria. For example, a good model may leave the SOC in a proper state for the next day. For example, even if the outcome for one day is good, the model should not leave the SOC at, for example, 99% or 1% for the next day, since there would be sufficient capacity for the next day. For example, the model should aim to keep the SOC in a reasonable range, such as 40%-80%, for the next day.

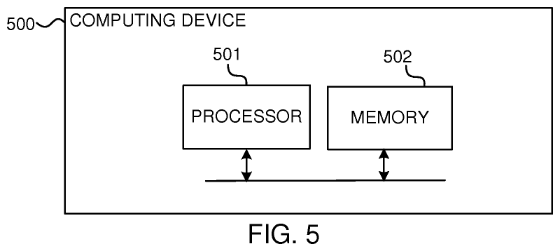

FIG. 5 illustrates a schematic representation of a computing device according to an embodiment.

According to an embodiment, a computing device 500 comprises at least one processor 501 and at least one memory 502 including computer program code, the at least one memory 502 and the computer program code configured to, with the at least one processor 501, cause the computing device 500 to perform the method 100.

The computing device 500 may comprise at least one processor 501. The at least one processor 501 may comprise, for example, one or more of various processing devices, such as a co-processor, a microprocessor, a digital signal processor (DSP), a processing circuitry with or without an accompanying DSP, or various other processing devices including integrated circuits such as, for example, an application specific integrated circuit (ASIC), a field programmable gate array (FPGA), a microprocessor unit (MCU), a hardware accelerator, a special-purpose computer chip, or the like.

The computing device 500 may further comprise a memory 502. The memory 502 may be configured to store, for example, computer programs and the like. The memory 502 may comprise one or more volatile memory devices, one or more non-volatile memory devices, and/or a combination of one or more volatile memory devices and non-volatile memory devices. For example, the memory 502 may be embodied as magnetic storage devices (such as hard disk drives, magnetic tapes, etc.) , optical magnetic storage devices, and semiconductor memories (such as mask ROM, PROM (programmable ROM), EPROM (erasable PROM), flash ROM, RAM (random access memory), etc. ).

The computing device 500 may further comprise other components not illustrated in the embodiment of FIG. 5. The computing device 500 may comprise, for example, an input/output bus for connecting the computing device 500 to other devices.

When the computing device 500 is configured to implement some functionality, some component and/or components of the computing device 500, such as the at least one processor 501 and/or the memory 502, may be configured to implement this functionality. Furthermore, when the at least one processor 501 is configured to implement some functionality, this functionality may be implemented using program code comprised, for example, in the memory.

The computing device 500 may be implemented at least partially using, for example, a computer, some other computing device, or similar.

Any range or device value given herein may be extended or altered without losing the effect sought. Also any embodiment may be combined with another embodiment unless explicitly disallowed.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts are intended to be within the scope of the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item may refer to one or more of those items.

The steps of the methods described herein may be carried out in any suitable order, or simultaneously where appropriate. Additionally, individual blocks may be deleted from any of the methods without departing from the spirit and scope of the subject matter described herein. Aspects of any of the embodiments described above may be combined with aspects of any of the other embodiments described to form further embodiments without losing the effect sought.

The term ‘comprising’ is used herein to mean including the method, blocks or elements identified, but that such blocks or elements do not comprise an exclusive list and a method or apparatus may contain additional blocks or elements.

It will be understood that the above description is given by way of example only and that various modifications may be made by those skilled in the art. The above specification, examples and data provide a complete description of the structure and use of exemplary embodiments. Although various embodiments have been described above with a certain degree of particularity, or with reference to one or more individual embodiments, those skilled in the art could make numerous alterations to the disclosed embodiments without departing from the spirit or scope of this specification.

1. A computer-implemented method for training at least one model for controlling asset allocation in a distributed energy system, the method comprising:
obtaining historical data about the distributed energy system;
training a data simulator to generate future data for future distributed energy system conditions using the historical data;
generating a plurality of new data for new distributed energy system conditions using the trained data simulator; and
training at least one model for controlling asset allocation in the distributed energy system in the new distributed energy system conditions using the plurality of new data;
wherein the training the at least one model for controlling asset allocation in the distributed energy system in the new distributed energy system conditions using the plurality of new data comprises:
obtaining at least one seed model from a database based at least on the new distributed energy system conditions; and
using the at least one seed model as a starting point for training the at least one model for controlling asset allocation in the distributed energy system in the new distributed energy system conditions;
wherein each seed model of the at least one seed model comprises energy and/or power characteristics of at least one asset of the at least one asset allocation plan.

2. The computer-implemented method according to claim 1, wherein each seed model of the at least one seed model further comprises at least one as-set allocation plan for the distributed energy system, statistical information about distributed energy system conditions at a time of execution of the at least one asset allocation plan, and/or an outcome probability distribution of the at least one asset allocation plan.

3. The computer-implemented method according to claim 2, wherein the statistical information about the distributed energy system conditions at the time of execution of the at least one asset allocation plan comprises at least one of: distributed energy system conditions before the time of execution of the allocation plan, prices before and/or during the time of execution of the at least one asset allocation plan, and/or frequency restoration reserves activation request signals before and/or during the time of execution of the at least one asset allocation plan.

4. The computer-implemented method according to claim 2, wherein the outcome probability distribution of the at least one asset allocation plan is based on a plurality of simulations and/or an observed outcome probability distribution of the at least one asset allocation plan.

5. The computer-implemented method according to claim 1, the method further comprising scaling the at least one seed model according to a capacity characteristic of the at least one seed model and a capacity characteristic of the new distributed energy system conditions.

6. The computer-implemented method according to claim 1, wherein the training the at least one model for controlling asset allocation in the distributed energy system in the new distributed energy system conditions using the plurality of new data further comprises:
training a plurality of models for the new distributed energy system conditions by using the at least one seed model as a starting point and by simulating each model in plurality of models a plurality of times, thus obtaining a plurality of trained models;
recording an outcome probability distribution of each trained model in the plurality of trained models; and
selecting a trained model, from the plurality of trained models, for execution based at least on the outcome probability distribution of each trained model in the plurality of trained models and at least one selection criteria.

7. The computer-implemented method according to claim 6, the method further comprising storing at least the selected trained model in the database.

8. The computer-implemented method according to claim 7, the method further comprising storing at least one non-selected trained model, from the plurality of trained models, in the database based at least on the outcome probability distribution of each trained model in the plurality of trained models and the at least one selection criteria.

9. The computer-implemented method according to claim 1, wherein the training the at least one model for controlling asset allocation in the distributed energy system in the new distributed energy system conditions using the plurality of new data comprises training the at least one model for controlling asset allocation in the distributed energy system in a plurality of distributed energy system conditions.

10. The computer-implemented method according to claim 1, wherein the energy and/or power characteristics of at least one asset of the at least one asset allocation plan comprises aggregate characteristics of an overall capacity being allocated.

11. The computer-implemented method according to claim 10, wherein the aggregate characteristics of the overall capacity being allocated comprise a capacity of usable energy storage, average adjustable power, and/or average up/down regulation power split.

12. The computer-implemented method according to claim 1, wherein the training the at least one model for controlling asset allocation in the distributed energy system in the new distributed energy system conditions allows a human to adjust the training.

13. The computer-implemented method according to claim 1, wherein the training the at least one model for controlling asset allocation in the distributed energy system in the new distributed energy system conditions comprises reinforcement learning.

14. A computing device, comprising at least one processor and at least one memory including computer program code, the at least one memory and the computer program code configured to, with the at least one processor, cause the computing device to perform the method according to claim 1.

15. A computer program product comprising program code configured to perform the method according to claim 1 when the computer program product is executed on a computer.
